(19) United States
(12) Patent Application Publication
(10) Pub. No.: US 2023/0166134 A1
(43) Pub. Date: Jun. 1, 2023

(54) FILTER MATERIAL AND PERSONAL PROTECTIVE MEANS BASED THEREON

(71) Applicant: ELECTROPHOR, INC., Woodmere, NY (US)

(72) Inventors: Joseph L. SHMIDT, Woodmere, NY (US); Aleksandr Gennadievich MITILINEOS, Saint-Petersburg (RU); Yuriy Evgenievich KAZAKEVICH, Saint-Petersburg (RU); Evgeniya Sergeyevna VASIL'YEVA, Saint-Petersburg (RU); Gleb Dmitrievich RUSINOV, Saint-Petersburg (RU); Alexander Alexandrovich CHERNYI, Saint-Petersburg (RU); Anastasia Nikolaevna VILKOVA, Gatchina (RU); Maria Anatol'evna FROLOVA, Saint-Petersburg (RU)

(21) Appl. No.: 17/918,272

(22) PCT Filed: Mar. 26, 2021
(86) PCT No.: PCT/RU2021/000130

§ 371 Date: Oct. 11, 2022

(30) Foreign Application Priority Data
Apr. 6, 2020 (RU) 2020112991

(51) Int. Cl. A62B 23/02; B01D 39/16; B01D 39/18; A62B 7/10; A62B 18/04

(52) U.S. Cl. CPC A62B 23/02; B01D 39/1623; B01D 39/18; A62B 7/10; A62B 18/04; B01D 2239/0407; B01D 2239/0442; B01D 2239/0618; B01D 2239/065; B01D 2239/0645; B01D 2239/0636; B01D 2239/1233; B01D 2239/1241; B01D 2239/1291

(57) ABSTRACT

Group of inventions relates to multilayer filtration materials for liquid or gas purification, which can be used purification systems for liquids, for example water from various sources, including drinking water, in ventilation systems or air filtration or for personnel or collective protective equipment production, including respiratory protective equipment, produced based on filtration materials.

Filtration material for liquid or gas purification, consisting of at least two layers, which liquid or gas flows one by one, where first layer is coarse filtration layer and is made on the base of nonwoven fibrous material, and second layer is a fine filtration layer on the base of filtration paper and/or filtration cardboard, characterized in that is configured to sorption filtration of liquid or gas, therein coarse filtration layer contains the particles with size of 2 to 500 mkm, predominantly from 5 to 200 mkm, at least of one type of sorbent, retained in the structure of nonwoven fibrous material, predominantly due to mechanical forces, and the second fine filtration layer contains particles with e size of 0.05 to 20 mkm, predominantly from 0.2 to 5 mkm of at least one fine-dispersed sorbent, retained in the structure of filtration paper and/or filtration cardboard predominantly due to adhesive forces.

Personal protective equipment made as helmet, consisting of body from predominantly transparent polymeric material with air inlet and outlet, collar from elastic polymeric material, and contains at least one air circulation means, therein air inlet and outlet openings are equipped with filters made of filtration material of the claim 1, therein in the inlet filter coarse filtration layer goes first to the environment, and the outlet filter—second fine layer of the filtration material.

Group of inventions relates to multilayer filtration materials for liquid or gas purification, which can be used in purification systems for liquids, for example water from various sources, including drinking water, in ventilation systems or air filtration or for personal or collective protective equipment production, including respiratory protective equipment, produced based on filtration materials.

Filtration materials for purification of different liquids, for example, water or oil and/or gases, for example, air and personal protective equipment based on them are known from the state of the arr. Main requirements to filtration materials are high efficiency (material must absorb maximum impurities) and long-term service. Filtration material with long-term service, but low efficiency and on the contrary, short-term service, but with high efficiency are known from the suite of the an.

Multilayer liquid filtration material of the U.S. Pat. No. 3,780,872 (applicant Pall Corp. priority 27 May 1968, IPC B01D 27/06) is known from the state of the art. Material of a U.S. Pat. No. 3,780,872 is canvas of several layers, where every layer is made of range of fibers interlaced between each other. Fiber of every following layer in the canvas interlocks the fiber of the previous layer. Two types of texture are claimed in the patent with overlap and folding, which is stronger than overlap in four times. To produce such material layers with different weaving are put against each other, and then are put under press bar and the layers are shifted against each other. As the layers are porous, the channels inside them are shifted too, forming tortuous path for liquid. But at the same time the inner size of the channels decreases and becomes approximately 50 mkm. Wire made of metals resistant to corrosion and inert for filtrated media can be used for fiber production.

Within the scope of the invention, material works as follows: liquid to be filtered passes the material layer by layer and is purified from mechanical debris, the size of which is bigger than pores in the layers. The drawback of the material of a U.S. Pat. No. 3,780,872 is high production costs (as metal fibers are used) along with low filtration efficiency (material eliminates only relatively big mechanical debris but does not delete absorbed debris). Also, such layers cannot be filled with sorbents as soon as structure is damaged under pressure, and as metal fiber is inert, sorbent cannot fix on fibers, and it will be washed away during filtration.

Filtration material for air purification of a U.S. Pat. No. 7,691,168 (applicant 3M Innovative Properties Company, priority 10 Oct. 2006. IPC B01D 24/00, D01D 5/20, H05H 1/26, A62B 7/10, B03C 3/00) is known from the state of the art. Filtration material consists of two layers—hydrocharged fibrous filtration layer, capable to absorb particles up to several mkm size and porous rofl-to-roll processable support layer. Hydrocharged fibrous filtration layer consists of interlaced fibers with size from 12 to 300 mkm, from 25 to 200 mkm, from 50 to 150 mkm, which are preliminary put into polar liquid, for example water, alcohols, ketones, or their mixtures and then are dried under conditions for fiber surface charge. Within the scope of claimed invention filtration material works as follows: the air passes the support layer, which mechanically eliminates large panicles and after that, air passes through fibrous filtration layer, which mechanically and due to electrostatic forces eliminates small particles from air. Filtration material of a U.S. Pat. No. 7,691,168 may be used for respiratory protective equipment production for example, in respirators. Filtration material of a U.S. Pat. No. 7,691,168 has a drawback. Charged surface within time can lose its power and filtration material will lose its efficiency. Also, this material is not effective towards small particles, which have no surface charge. So, the main drawback of this material is its low efficiency.

Filtration material Ahlstrom Disruptor 5283 (produced by Ahlstrom-Munksjo, Sweden, https://www wasser-primus.com/wp-content/uploads/Grayl-Filtration-Alstrom-Disruptor-Presentation-2011-1.pdf), is known from the state of the art and is chosen as the closest analogue. This filtration material consists of macrofibers, for example glass, covered with boehmite (aluminium oxyhydroxide, which are added to composition of fibrous material during non-woven fabric production. Produced material is laid between spunbond layers to increase strength. The length of macofibers covered with boehmite varies from 2 to 250 nm. Crystal structure of boehmite creates electrokinetic potential on fiber's surface. Material Ahlstrom Disruptor 5283 has multilayered pore structure. Within the scope of invention, such material works as follows: liquid to be filtered flows through the material layer and is purified from impurities. The main drawback of the material is that efficiency of it relates to electrokinetic potential on the fibers surface, during sorption of debris the potential changes, the material stops to absorb impurities, so it has short service time.

Filtration material of a U.S. Pat. No. 4,976,8558 (applicant Toyo Roki Kabushiki Katsha, priority 1 Feb. 1990,1PC. B01D 39/14), is known from foe state of foe an and chosen as the closest analogue. Filtration material of a U.S. Pat. No. 4,976,858 consists of at least two layers fused to each other. Liquid or gas flows layers of different density layer by layer. The first layer is coarse filter and is made of nonwoven fibrous fabric and is denser, then the second. The second layer is made of filtration paper and is a fine filter. Additional layers of different density may lay between two main layers. Filtration material is intended for mechanical liquid filtration and within the scope of the claims works as follows: filtered liquid flows layer by layer, large panicles are mechanically absorbed in the first layer, and fine particles are absorbed in the second layer. Filtration material of the U.S. Pat. No. 4,976,858 has foe essential drawback, as purifies liquid only mechanically, but it can't absorb dissolved impurities. Also, layers of such material cannot be filled with any sorbents as sorbent may be fixed in the layers only due to mechanical forces (surface roughness of sorbent and layers). During filtration sorbent may be washed of by the liquid flow. So, the main drawback of this material is its low efficiency.

Personal protective equipment of a patent EP 2376168 (applicant Intersurgical S.P.A., priority Mar. 12, 2008, IPC A61M 16/06, A 62B 17/04) is known from the state of the an. Personal protective equipment is made in the form of helmet, consisting of body predominantly of transparent polymeric material with openings for air inlet and outlet, collar of elastic polymeric material and firm collar support. Air inlet may be connected to stationary or portable oxygen source, and that is the drawback of the given personal protective equipment as significantly narrows the area of its use.

Personal protective equipment of utility model patent RU65385 (applicant ZAO “Northwest scientific-technical center “A.A. Gunayev Portable personal protective equipment”, priority 28 Mar. 2007, IPC A62B 15/00, A62B 17/04). Personal protective equipment is a helmet, consisting of the body, predominantly made of transparent polymeric material and skirt (sealing cup), sealingly connected by its upper edge to the edge of helmets neck. T here is an opening in the skirt for exhalation valve. This skirt may be made of fibrous polymeric filtration material or of fibrous polymeric filtration material of Petraynov filter, filled with powdered sorbents, and of ion-exchange fibrous filtration or of activated carbon fibrous material with sorbing properties. Optionally personal protective equipment maybe equipped with protective half-mask of sorbing and filtration material, attached to the skirt with exhalating valve. Within the scope of the invention indicated personal protective equipment works as follows. When the user breathes in the exhalating valve is closed and exhaustion occurs in the space under protective hood. Due to exhaustion under the skin contaminated air flows through skirts of filtration material. Air purifies only from aerosols or from aerosols, gases, and vapors, and flows into the space under the skirt. Due to exhaustion under half-mask, air predominantly purified by material of the skirt, flows through filtration material of the half-mask, additionally purifies, and then flows to the user. When user breathes out due to excessive pressure in the space under half-mask exhalation valve opens and the air breathed out flows out personal protective equipment of utility mode patent RU65385 has the following drawbacks. First one is that during filtration process moisture drops, containing microorganisms are mechanically retained by filtration material and then microorganisms exist and may develop in the material, in this case, personal protective equipment becomes potential source of infection. Secondly, filtration material has short service time, so filter elements must be changed more often. Also, the other drawback is that air breathed out flows into the environment without any filtration, so the user himself may be the source of infection.

Personal protective equipment of a U.S. Pat. No. 4,620,538 (applicant The United States of America as represented by Secretary of Air Force, priority 19.03.1985, IPC A61H 31/00) and chosen by the applicant as the closest analogue is known from the state of the art. Personal protective equipment of a U.S. Pat. No. 4,620,538 is made as a helmet, consisting of the body made predominantly of transparent polymeric material with openings for oxygen inlet and air outlet, elastic inflating collar and two adjusting rings, lire air outlet is equipped with non-return valve, which preserves inner space of tire helmet from the ambient air. Within the scope of the invention indicated personal protective equipment works as follows: the user puts on the helmet, adjusts the size of inflating to make it airtight to the neck. When user breathes in, oxygen flows into the helmet though inlet opening, and the air breathed out flow s out of inner space of the helmet into the environment. Main drawbacks of the given invention are the absence of filtration materials in the equipment and the obligatory oxygen source. Also, tire given embodiment does not filtrate the breathed-out air before it flows into environment.

Object of tire invention and the technical result are achieved by developing of new filtration material for liquid or gas purification with high efficiency to impurities filtration and with long service life and personal protective equipment on its bases, which protects the user from the environment and on the contrary.

Problem to be solved and technical result to be achieved by that filtration material for liquid or gas purification, consisting of at least two layers, which liquid or gas flows one by one, where first layer is coarse filtration layer and is made on the base of nonwoven fibrous material, and second layer is a fine filtration layer on the base of filtration paper and/or filtration cardboard, characterized in that is configured to sorption filtration of liquid or gas, tire rein coarse filtration layer contains the particles with size of 2 to 500 mkm, predominantly from 5 to 200 mkm, at least of one type of sorbent, retained in the structure of nonwoven fibrous material, predominantly due to mechanical forces, and the second fine filtration layer contains particles with e size of 0.05 to 20 mkm, predominantly from 0.2 to 5 mkm of at least one fine-dispersed sorbent, retained in tire structure of filtration paper and/or filtration cardboard predominantly due to adhesive forces. Therein, for example, but not limited to, activated carbons, activated carbon fibers, fibrous ion exchange materials, for example on the base of polyacrylonitrile, subsoil resources carbons, silica gels, alumina gels, alumina silicates, diatomite, ion exchange resins, chitin, chitosanase, sorbents on the base of metal oxides and hydroxides mixtures of indicated sorbents can be used as the first coarse layer, and for example, but not limited to, activated carbons, activated carbon fibers, fibrous ion exchange materials, for example on the base of polyacrylonitrile, subsoil resources carbons, silica gels, alumina gels, alumina silicates, diatomite, sorbents on the base of metal oxides and hydroxides mixtures of indicated sorbents can be used as the second fine filtration layer. Also, filtration paper and/or carboard of the second fine filtration layer is a composite, containing predominantly up to 50% of fibers on the base of cellulose and may additionally contain up to 30% of selective fibrous ion exchange material and from 0,001 to 2%, predominantly from 0,004 to 0.1%, flocculant, which may be neutral, cationic, anionic or cationic-anionic, for example, but not limited to, polyvinyl alcohol, polyoxythelens, polyacrilimides, polyacrylates, polymetacrylates, partly partially hydrolyzed polyacrylamide. Therein tire second fine filtration layer has an increased sorption ability to retain powdered sorbent particles, washed or blown off from the first layer during filtration. The surface of the first coarse filtration layer is rougher, than the surface of the second fine filtration layer, therein the liquid predominantly evenly spreads when flowing out from the first coarse layer and coming into the second fine filtration layer. Also, at least one of the layers may be corrugated, and the material itself may additionally contain one or more filtration layers before and after the first or the second filtration layers, and be made of, for example, but not limited, spun bond, carbon nonwoven fiber, meshy polymeric material, for example, dividing porous polymeric net or fibrillated porous film graphene film. Also problem to be solved and technical result to be achieved by that, filtration material for liquid or gas purification may be used to produce personal protective equipment, including, but not limited gas masks of different configuration, and personal protective equipment on its base is made as helmet, consisting of body from predominantly transparent polymeric material with air inlet and outlet, collar from elastic polymeric material, and contains at least one air circulation means, therein air inlet and outlet openings are equipped with filters made of claimed filtration material, therein in the inlet filter coarse filtration layer goes first to the environment, and the outlet filter—second fine layer of the filtration material. There in air circulation means is made as, for example, but not limited to, as compressor, pump or ventilator Also, personal protective equipment may additionally contain membrane valve, configured to consume water and spoon-food without taking off the personal protective equipment, a collar made of elastic polymeric material configured to regulate its size bymeans of air supply into the inner cavity of the collar.

Disclosure of the group of the inventions is illustrated by the figures:

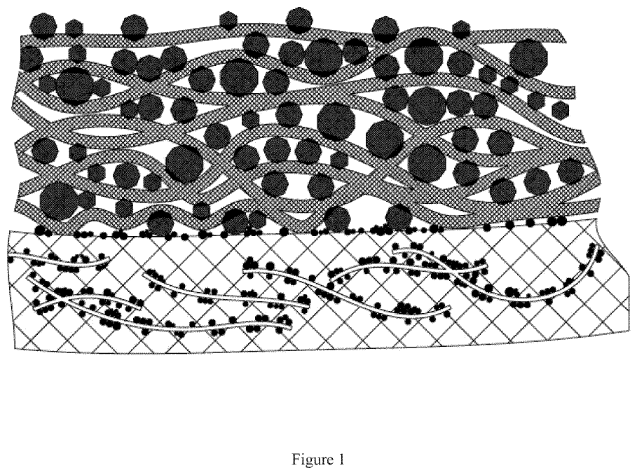

The schematic image of the filtration material structure is given on the FIG. 1.

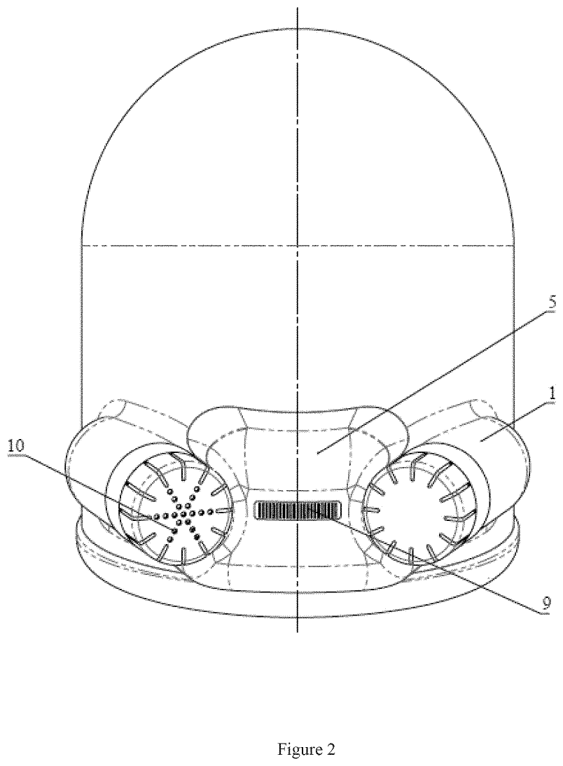

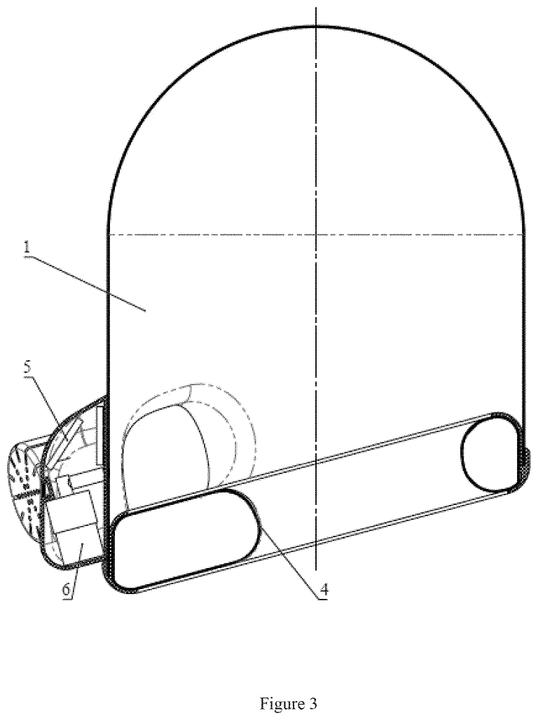

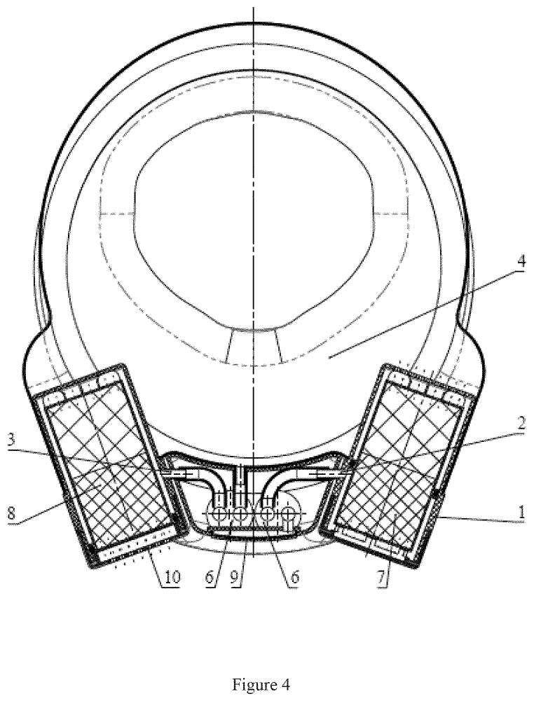

An example of the personal protective equipment appearance from different angels is given on the FIGS. 2-4.

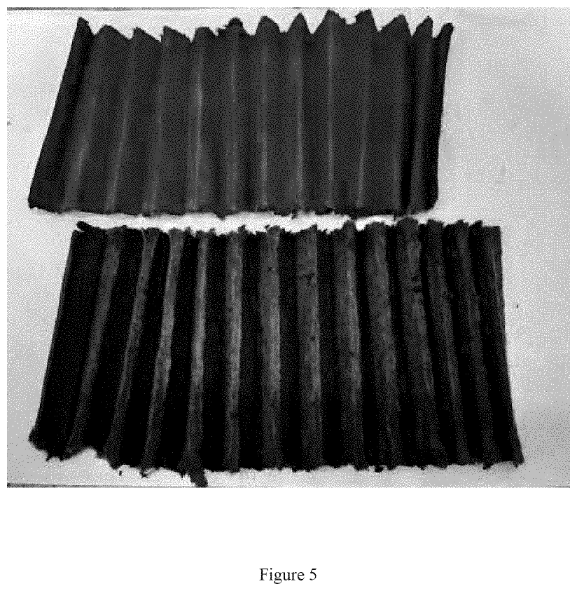

The photo of coarse and fine layers of the filtration material appearance after ferrum colloid filtration trails are given on the FIG. 5.

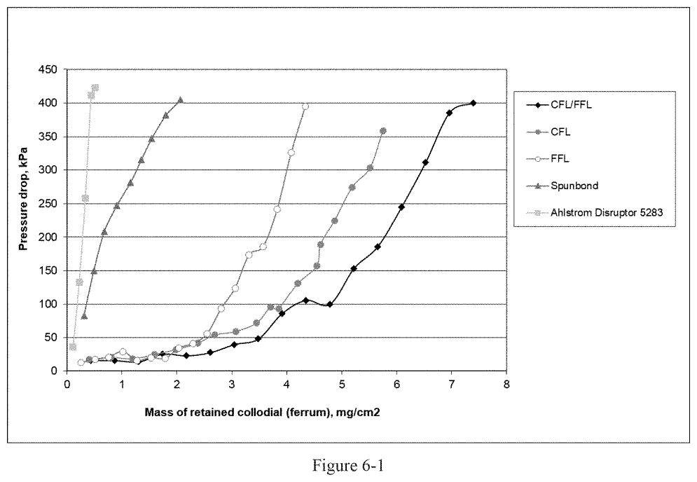

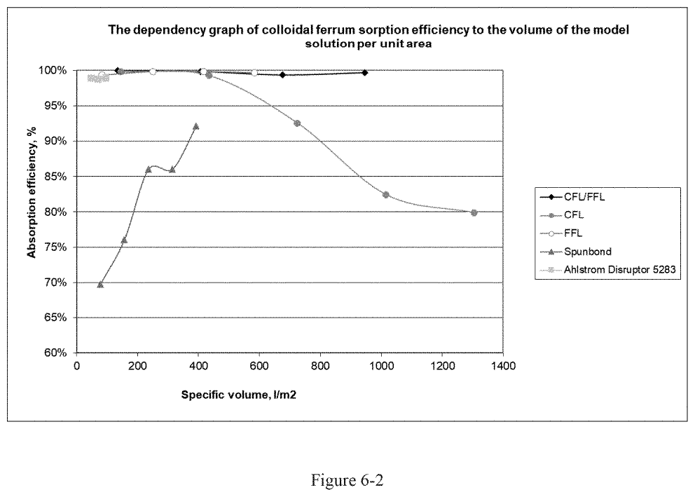

Experimental data, where 6-1 the diagram of pressure difference from colloid ferrum absorbed mass per unit area. 6-2—the diagram of ferrum colloid absorption effectiveness from the volume of model solution per unit area of material are given on the FIG. 6 (6-1, 6-2).

Filtration material for liquid or gas purification consists predominantly of two obligatory layers, which filtrated liquid or gas flow consequently. Therein at least one of the layers may be corrugated.

First layer—coarse layer—is made on the base of nonwoven fibrous material for example from the hydrophobic polyolefin fibers with fiber diameter from 5 to 30 mkm and is filled with particles with size from 2 to 500 mkm, predominantly from 5 to 200 mkm, at least of one type of sorbent. Material of the first layer is aerodynamic-laid web from fibers, produced by extruding the polymer melt through the nozzle into the transporting gas flow with simultaneous supply of granulated or powdered sorbent. Therein the particles of the sorbent not only engage to the fibers surface, but due to high temperature melt with the fibers and so mechanically attach to them. Activated carbons, activated carbon fibers, fibrous ion exchange materials, for example on the base of polyacrylonitrile, subsoil resources carbons, silica gels, alumina gels, alumina silicates, diatomite, ion exchange resins, chitin, chitosanase, sorbents on the base of metal oxides and hydroxides mixtures of indicated sorbents may be used, but not limited to, as sorbents of the first coarse layer. Indicated sorbents may be additionally manufactured with bactericidal agent, for example, but not limited to, for example, silver containing agent.

Second layer—fine filtration layer—is a composite material up to 50% consisting of cellulose fibers with fiber length from 0.5 to 3 mm, diameter from 5 to 30 mkm, predominantly from 5 to 25 mkm, selective fibrous sorbent (not more than 30% of overall mass), uitradisperse particles of the sorbent with the size from 1 to 25 mkm, predominantly from 2 to 20 mkm, and also flocculant in amount from 0,001 to 2%, predominantly from 0,004 to 0.1%. Activated carbons, activated carbon fibers, fibrous ion exchange materials, for example on the base of polyacrylonitrile, subsoil resources carbons, silica gels, alumina gels, alumina silicates, diatomite, sorbents on the base of metal oxides and hydroxides mixtures of indicated sorbents can be used as uitradisperse particles for the second fine filtration layer. Indicated sorbents may be additionally manufactured with bactericidal agent, for example, but not limited to, for example, sliver containing agent. Flocullant may be neutral, cationic, anionic, or cat ionic—an ionic, for example, but not limited to, polyvinyl alcohol, polyoxythelens, polyacrilimides, polyacrylates, polymetacrylates, partly partially hydrolized polyacrylamide. Due to that the material of the second layer consists mostly of cellulose fibers, it is produced by handsheet with further drying and pressure molding. Uitradisperse particles attach to the fibers mostly due to adhesion forces. Besides the second fine filtration layer has an increased sorption ability to retain powdered sorbent particles, washed off or blown front the first layer during filtration.

Produced filtration material has hydrophobic-hydrophilic properties. These properties mostly are arranged by the fibers of different type. Hydrophobic fibers are prevailed in the first layer, hydrophilic—in the second. Hydrophobic-hydrophilic properties of the sorbent provide increased efficiency during hydrophobic-hydrophilic impurities, for example viruses. Therein the claimed material is bacteriostatic.

First layer has rougher surface, than the second. Unevenness is the ratio between fibers diameter and size of sorbent particles. First filtration layer contains the fibers with diameter from 5 to 30 mkm and particles size from 2 to 500 mkm, predominantly from 5 to 200 mkm. Second filtration layer contains the fibers with diameter from 5 to 30 mkm and particles size from 1 to 25 mkm, predominantly from 2 to 20 mkm. Sc, the unevenness of the surface of die first layer is at least by one order more than unevenness of the second layer.

This provides dispersion of liquid flow after it comes from the first layer before it enters the second layer, so that if even the part of the pores of the first layer is clogged with large mechanical particles, the second layer totally takes part in filtration process. If the material of the first layer is blocked with particles, all the channels of the second layer remain opened for liquid and gas flow. So, during filtration totally or partly acts the volume of the first layer and all the volume of the second layer of the filtration material, increasing velocity and purification rate.

Besides the indicated layers the filtration material may additionally contain one or more filtration layers before and after the first or the second filtration layers, and lie made of, for example, but not limited, spunbond, carbon nonwoven fiber, meshy polymeric material for example, dividing porous polymeric net or fibrillated porous film, graphene film.

Within the characteristic features claimed filtration material acts as follows. Liquid or gas to be filtrated flows into the first layer, where the first filtration sup takes place. As the average panicle size of the first layer sorbent is predominantly bigger than the average diameter of fibers of the first layer, the first layer has extended surface (big number of pores) and has high contaminant capacity and ability to absorb the impurities slowly. After the first layer, liquid or gas to be filtrated flow into the second layer, therein when the liquid is purified, after the first layer liquid uniformly spreads when flowing to the second layer. The second filtration step takes place in the second filtration layer. The second layer has an extended surface (big number of pores) either and simultaneously sorbent particles of the second layer have high kinetic ability to absorb dissolved impurities. Besides, if powdered b panicles of the sorbent of the first layer are washed or blown off, the second layer blocks them. Purified liquid or gas go to the user after the second purification layer.

The described mechanism of the filtration material operation is also confirmed by experimental data. The photo of coarse and fine layers of the filtration material appearance after ferrum colloid filtration trails are given on the FIG. 5. Filtration material after the trails was divided into the layers, each of diem was photographed, therein on the photo (FIG. 5) the coarse filtration layer is above the second fine filtration layer. It is seen (FIG. 5) that most of the ferrum hydroxide particles were absorbed by the first coarse layer and the smallest particles, which came through the first layer were retained in the second layer.

Compared to the closest analog it is an advantage that the second layer can absorb powdered particles washed off from the first layer. In the closest analog sorbent retention is due to mechanical forces, so the sorbent will be washed off and that will decrease the efficiency of the material, and worse the usability, as purified liquid or gas will contain the sorbent particles. The sorbent particles, left in the purified gas limits the material use in the personal protective equipment, so the claimed material is the new one, but not the combination of analog and other sorbents from the state of the art.

Efficiency of the claimed filtration material of liquid filtration is confirmed by comparative trails of colloidal ferrum absorption in the experimental cartridges of 100 mm high, made as radial filtration cartridge with typical carbon block in the center and corrugated wrap made of different filtration materials, specifically spun bond with surface density 100 g/m² (polypropylene, manufacturer OOO “Konglomerat” LLC, Russia) (the indicated material was chosen from the state of the art and widely spread on the market of filtration materials with long service life) material of Ahlstrom Disruptor 5283 (manufacturer Ahlstrom-Munksjo, Sweden) (the indicated material was chosen from the state of the art and widely spread on the market of filtration materials with high purification efficiency), first coarse layer and second fine layer apart, the claimed composite flirtation material. The results of trails are given in the table 1.

As the filtration material of a U.S. Pat. No. 4,976,858 is not available on the market, to confirm the technical result, the claimed filtration material was compared to the materials with long service life and high purification efficiency known from the state of the art.

TABLE 1

| | | Mass of retained colloid | |
|---|---|---|---|
| | | (in terms of iron), mg/cm² | |
| | | At a | At a |
| | Minimum | pressure | pressure |
| | absorption | drop of | drop of |
| Corrugated wrapping makeup | efficiency, % | 200 kPa | 300 kPa |
| Spun bond | 70 | 0.7 | 1.3 |
| Ahlstrom Disruptor 5283 | 98.7 | 0.3 | 0.4 |
| Coarse filtration layer | 80 | 4.8 | 5.5 |
| (further - CFL) | | | |
| Fine filtration layer | 99.3 | 3.6 | 4.0 |
| (further - FFL) | | | |
| Composite material: | 99.4 | 5.8 | 6.5 |
| CFL/(FFL) | | | |

The trails were held on the bench tester with automatic supply of the mode solution of colloidal ferrum hydroxide, concentration 60±10 mg/dm³ tin conversion to ferrum; and constant volume flowrate 1000 sm³/min.

During trails pressure drop (to 400 kPa) and absorption efficiency of colloidal ferrum where indicated. The total amount of ferrum was measured by spectrophotometric method.

To compare the buildup of pressure drops for different materials of different geometry, the conversion into the volume units per unit area of the material was made.

The sorption of colloidal ferrum efficiency was made according to formula:

$$E , \% = \frac{( Cinitial - Cflitrated )}{Cinitial} \cdot 100 \% ,$$

where E,%—sorption of colloidal ferrum efficiency, %; Cimitial—mode ferrum colloidal solution concentration; Cfiltrated—the ferrum concentration in solution after purification.

The results are given in the Table 1 and on the FIG. 6, where 6-1—is the dependency graph of mass of colloidal ferrum per unit area, 6-2—is the dependency graph of colloidal ferrum sorption efficiency to the volume of the model solution pet unit area.

Comparison trails showed that filtration material, consisting of layer by layer of coarse and fine filtration materials has both high absorption efficiency and low flow resistance in comparison to traditional prefiltration material or layers themselves. Low flow resistance of liquid means that, filtration material clogs slowly, and so has long service life. So, claimed material has high absorption efficiency and long service life, so the experimental data confirm the technical result.

As it was said before, claimed filtration material may be used in personal protective equipment.

Personal protective equipment (FIGS. 2-4) is made as a helmet and consists of a body (1) from predominantly transparent polymeric material with air inlet (2) and outlet (3), collar (4) from elastic polymeric material, and one air circulation means (6). Also, personal protective equipment may comprise electric power supply unit (not shown) and control panel (5). Air inlet (2) and outlet (2) openings are equipped with filters (7, 8) made of claimed filtration material. Therein in the inlet filter (7) coarse filtration layer goes first to the environment, and the outlet filter (8)—second fine layer of the filtration material.

Air circulation means (6) is made as, for example, but not limited to, as compressor, pump or ventilator.

The size of the collar is regulated by means of air supply into the inner cavity of the collar (4).

Respiratory protective equipment works as follows. The user draws on the equipment and pumps the collar (4) to the required size and fixates the equipment airtight around the neck. When the equipment is turned on, the air circulation means (6) starts to supply air through inlet filter (7). Filtration material works as follows. Air flows through consequently first and then the second layers of the material, filtrating from mechanical and other impurities. When the user breathes in-out the air, which is aerosol, its particles get into the material and due to its hydrophobic-hydrophilic properties are retained there. The moisture is dried due to air circulating means (6) operation, and impurities remain on the sorbent's granules surface. Due to the indicated properties of the filtration material, liquid or gas purification is done mire quick and effective, then in the material of the closest analogue. During the operation of the equipment the used air flows out from outlet opening (3), equipped with the outlet filter (8) into the environment.

The advantage of the proposed personal protective equipment is that the filter material is highly efficient and can absorb viruses, among other things. As mentioned earlier, the inventive filter material is preferably bacteriostatic, which means that the risk of microorganisms and viruses developing on the surface of the filter material is reduced, thus, personal protective equipment based on the specified filter material is safe to maintain (there is no danger of bacteriological contamination when replacing the filter material in personal protective equipment).

Since the claimed protective equipment has both an inlet and an outlet filter, and the air circulation means provides an unambiguous movement of flows, the air exhaled by the user necessarily passes through the outlet filter, that is, the personal protective equipment protects not only the user from the environment, but also the environment from the user, thus ensuring die achievement of a technical result.

The description of the present invention submits a preferred embodiment of the invention. It can be changed within the claimed set of the claims, so the wide use of the invention is possible.

1. Filtration material for liquid or gas purification, consisting of at least two layers, which liquid or gas flows one by one, where first layer is coarse filtration layer and is made on the base of nonwoven fibrous material, and second layer is a fine filtration layer on the base of filtration paper and/or filtration cardboard, characterized in that is configured to sorption filtration of liquid or gas, therein coarse filtration layer contains the particles with size of 2 to 500 mkm, predominantly from 5 to 200 mkm, at least of one type of sorbent, retained in the structure of nonwoven fibrous material, predominantly due to mechanical forces, and the second fine filtration layer contains particles with e size of 0.05 to 20 mkm, predominantly from 0.2 to 5 mkm of at least one fine-dispersed sorbent, retained in the structure of filtration paper and/or filtration cardboard predominantly due to adhesive forces.

2. Filtration material for liquid and gas purification according to claim 1, characterized in that according to claim 1, as the first coarse filtration layer, but not limited to, can be used activated carbons, activated carbon fibers, fibrous ion exchange materials, for example on the base of polyacrylonitrile, subsoil resources carbons, silica gels, alumina gels, alumina silicates, diatomite, ion exchange resins, chitin, chitosanase, sorbents on the base of metal oxides and hydroxides mixtures of indicated sorbents.

3. Filtration material for liquid and gas purification according to claim 1, characterized in that, as the second fine filtration layer, but not limited to, can be used activated carbons, activated carbon fibers, fibrous ion exchange materials, for example on the base of polyacrylonitrile, subsoil resources carbons, silica gels, alumina gels, alumina silicates, diatomite, sorbents on the base of metal oxides and hydroxides mixtures of indicated sorbents.

4. Filtration material for liquid and gas purification according to claim 1, characterized in that the filtration paper and/or carboard of the second fine filtration layer is a composite, containing predominantly up to 50% of fibers on the base of cellulose.

5. Filtration material for liquid and gas purification according to claim 1, characterized in that the filtration paper and/or carboard of the second fine filtration layer may additionally contain up to 30% of selective fibrous ion exchange material

6. Filtration material for liquid and gas purification according to claim 1, characterized in that the filtration paper and/or carboard of the second fine filtration layer may additionally contain from 0,001 to 2%, predominantly from 0,004 to 0.1% of flocculant.

7. Filtration material for liquid and gas purification according to claim 6, characterized in that flocculant may be neutral, cationic, anionic, or cationic-anionic, for example, but not limited to, polyvinyl alcohol, polyoxythelens, polyacrilimides, polyacrylates, polymetacrylates, partly partially hydrolized polyacrylamide.

8. Filtration material for liquid and gas purification according to claim 1, characterized in that second fine filtration layer has an increased sorption ability to retain powdered sorbent particles, washed off or blown from the first layer during filtration.

9. Filtration material for liquid and gas purification according to claim 1, characterized in that the surface of the first coarse filtration layer is rougher, than the surface of the second fine filtration layer, therein the liquid predominantly evenly spreads when flowing out from the first coarse layer and coming into the second fine filtration layer.

10. Filtration material for liquid and gas purification according to claim 1, characterized in that at least one of the layers may be corrugated

11. Filtration material for liquid and gas purification according to claim 1, characterized in that the material may additionally contain one or more filtration layers before and after the first or the second filtration layers, and be made of, for example, but not limited, spun bond, carbon nonwoven fiber, meshy polymeric material, for example, dividing porous polymeric net or fibrillated porous film, graphene net.

12. Filtration material for liquid and gas purification according to claim 1, characterized in that filtration material for liquid or gas purification may be used to produce personal protective equipment, including, but not limited gas masks of different, configuration

13. Personal protective equipment made as helmet, consisting of body from predominantly transparent polymeric material with air inlet and outlet, collar from elastic polymeric material, and contains at least one air circulation means, therein air inlet and outlet openings are equipped with filters made of filtration material of the claim 1, therein in the inlet filter coarse filtration layer goes first to the environment, and the outlet filter—second fine layer of the filtration material.

14. Personal protective equipment according to claim 13, characterized in that air circulation means is made as, for example, but not limited to, as compressor, pump or ventilator.

15. Personal protective equipment according to claim 13, characterized in that may additionally contain membrane valve, is configured to consume water and spoon-food without taking off the personal protective equipment.

16. Personal protective equipment according to claim 13, characterized in that a collar made of elastic polymeric material is configured to regulate its size by means of air supply into the inner cavity of the collar.
